(19) United States
(12) Patent Application Publication
(10) Pub. No.: US 2018/0080604 A1
(43) Pub. Date: Mar. 22, 2018

(54) MAGNETIC OBJECT SUSPENSION APPARATUS AND ASSOCIATED METHODS AND SYSTEMS

(71) Applicant: Conti-Bros, Inc., Greenville, SC (US)

(72) Inventor: Brian Vincent Conti, Matthews, NC (US)

(21) Appl. No.: 15/709,358

(22) Filed: Sep. 19, 2017

Related U.S. Application Data
(60) Provisional application No. 62/397,182, filed on Sep. 20, 2016.

(51) Int. Cl. F16M 13/02; F16B 1/00; A47B 97/00

(52) U.S. Cl. CPC F16M 13/022; F16B 2001/0035; A47B 97/00; F16B 1/00

(57) ABSTRACT

Apparatuses for magnetically suspending an object within a space are provided with associated methods and systems. One example apparatus includes an apparatus for suspending an item includes a carrier including a chamber and a hook. The hook is configured to engage a rod of a shelf to removably secure the apparatus to the shelf. The magnet is disposed within the chamber. Additional example apparatuses, as well as systems and methods are also provided.

### CROSS-REFERENCE TO RELATED APPLICATIONS

This application claims the benefit of U.S. Provisional Application No. 62/397,182 filed on Sep. 20, 2016, the entire contents of which are hereby incorporated by reference.

### TECHNOLOGICAL FIELD

Various embodiments of the present invention relate generally to organizational and optimal space utilization systems and associated methods.

### BACKGROUND

In any physical space there is always a desire to maximize the utilization of that space and avoid unused or wasted space. Space-saving technologies continue to evolve and be implemented in new and unexpected ways, largely fueled by the demand to maximize space utilization and organization. Spaces that can benefit from these technologies include, but are not limited to, closets, garages, cabinets, refrigerators, or any other enclosed space. In addition to space saving, there is a continued demand for convenient organization solutions that place a desired object in an easy-to-access location. As such, convenient, organized, space optimizing technologies for these and other physical spaces will continue to be in high demand, thereby spurring innovation to meet the consumer's needs and desires.

### BRIEF SUMMARY

Some example embodiments are therefore described that provide for suspending an item. Apparatuses for magnetically suspending an object within a space are provided with associated methods and systems. One example apparatus includes an apparatus for suspending an item includes a carrier including a chamber and a hook. The hook is configured to engage a rod of a shelf to removably secure the apparatus to the shelf. The magnet is disposed within the chamber. Additional example apparatuses, as well as systems and methods are also provided.

### BRIEF DESCRIPTION OF THE SEVERAL VIEWS OF THE DRAWING(S)

Having thus described various example embodiments of the invention in general terms, reference will now be made to the accompanying drawings, which are not necessarily drawn to scale, and wherein:

FIG. 1 is a top view of an apparatus for suspending an item according to an example embodiment;

FIG. 2 is a side view of an apparatus for suspending an item according to an example embodiment;

FIG. 3 is a bottom view of an apparatus for suspending an item according to an example embodiment;

FIG. 4 is a perspective top view of an apparatus for suspending an item according to an example embodiment;

FIG. 5 is a exploded, perspective top view of an apparatus for suspending an item according to an example embodiment;

FIG. 6 is a cross-section view of a portion of an apparatus for suspending an item at the section line A-A of FIG. 1 according to an example embodiment;

FIG. 7a is a top view of a magnet according to an example embodiment;

FIG. 7b is a cross-section view of a portion of a magnet at the section line B-B of FIG. 7a according to an example embodiment;

FIG. 7c is a side view of a magnet according to an example embodiment;

FIG. 8 is a top, perspective view of an apparatus for suspending an item removably secured to a shelving rods according to some example embodiments;

FIG. 9 is a top view of an apparatus for suspending an item removably secured to a shelving rods according to some example embodiments;

FIG. 10 is a side view of an apparatus for suspending an item removably secured to a shelving rods according to some example embodiments;

FIG. 11 is a top, perspective view of an apparatus for suspending an item removably secured to shelving rods and suspending an item according to some example embodiments;

FIG. 12 is a top view of an apparatus for suspending an item removably secured to a shelving rods and suspending an item according to some example embodiments; and

FIG. 13 is a side view of an apparatus for suspending an item removably secured to a shelving rods and suspending an item according to some example embodiments.

### DETAILED DESCRIPTION

Some example embodiments of the present invention or inventions will now be described more fully hereinafter with reference to the accompanying drawings, in which some, but not all embodiments are shown. Indeed, the various example embodiments may take many different forms and the inventions should not be construed as being limited to the example embodiments set forth herein; rather, these example embodiments are provided so that this disclosure will satisfy applicable legal requirements. Like reference numerals refer to like elements throughout.

According to various example embodiments, an apparatus or device for suspending an item is provided. The apparatus may be removably secured to rods of a shelf (e.g., wire rods) in, for example, a pantry of a home. In this regard, according to some example embodiments, the apparatus may include hooks on two sides of the apparatus that are configured to engage with rods of a shelf to secure the apparatus to an underside of the shelf and facilitate the apparatus' ability to suspend an item. The apparatus may employ one or more magnets to attract and suspend an item having a ferrous materiel a component. According to some example embodiments, the item may be, for example, a steel can. The can may be suspended by the apparatus due to the magnet's attraction to the ferrous component of the can. The magnet or magnets may be formed to have a sufficient magnetic pull or force to suspend the weight of a can and its contents.

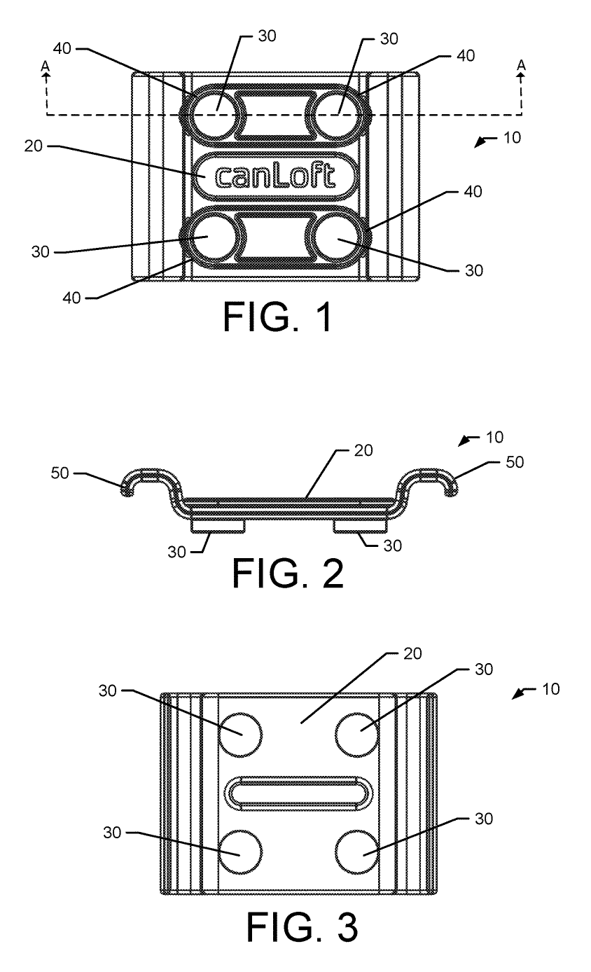

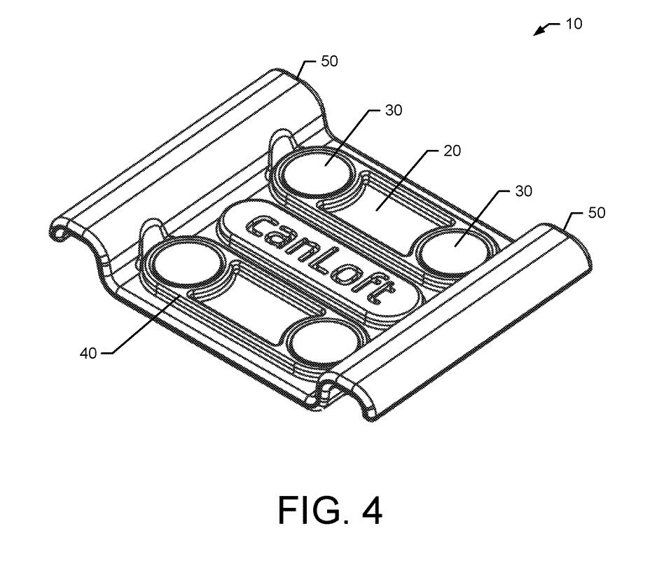

FIG. 1 is a top view of an apparatus for suspending an item according to an example embodiment. The apparatus 10 may include a carrier 20 and magnets 30. The carrier 20 may include chambers 40 within which a respective magnet may be secured. The chambers 40 may pass entirely through the body of the carrier 20 or the chambers may be closed on one or both ends to form a cup or an enclosed cavity, respectively. The carrier 20 may be constructed of any non-ferrous material, such as, for example, plastic. In this regard, the carrier 20 may be injection molded. While the carrier 20 of FIG. 1 includes four magnets 30, according to various example embodiments, the carrier 20 may house any number of magnets 30. According to some example embodiments, the number and size of the magnets may be selected based on the weight and distribution of ferrous material in the item to be suspended for given use case.

FIG. 2 is a side view of an apparatus for suspending an item according to an example embodiment. As best seen in FIG. 2, the carrier 20 may include hooks 50. The hooks 50 may, in some example embodiments, be disposed on two opposite sides of the carrier 20. The hooks 50 may be constructed so as to facilitate engagement with rods of a shelf. When engaged with the rods of a shelf, the hooks 50 operate to suspend the apparatus 10 from the rods. Additionally, The magnets 30 may be secured into the carrier 20 such that the magnets extend beyond a bottom surface of the carrier to facilitate, according to some example embodiments, direct physical contact between the magnets 30 and the item to be suspended.

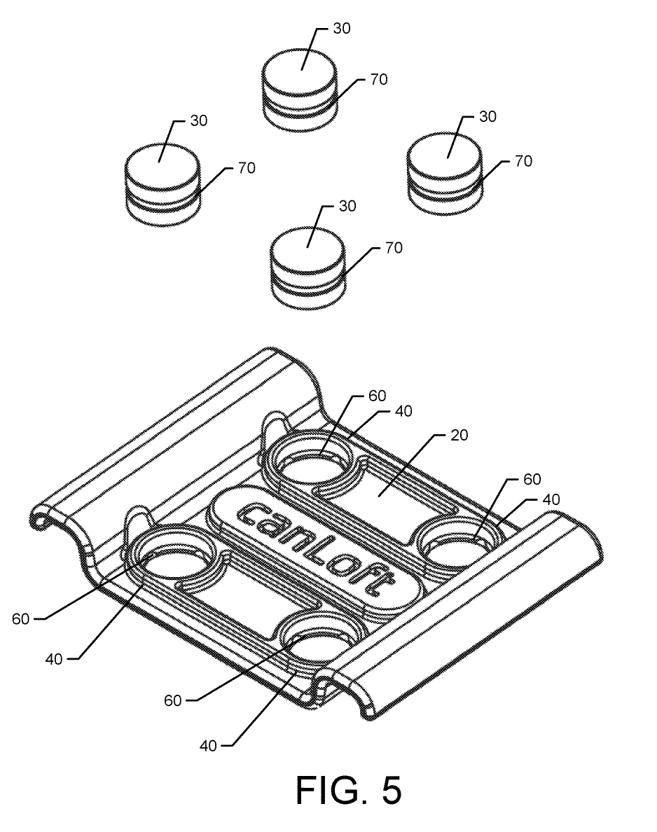

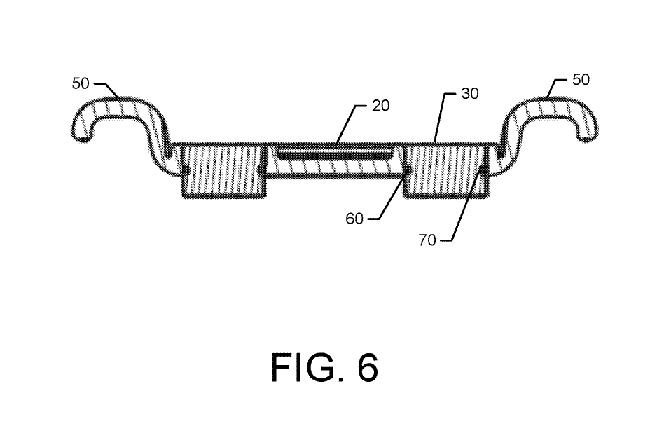

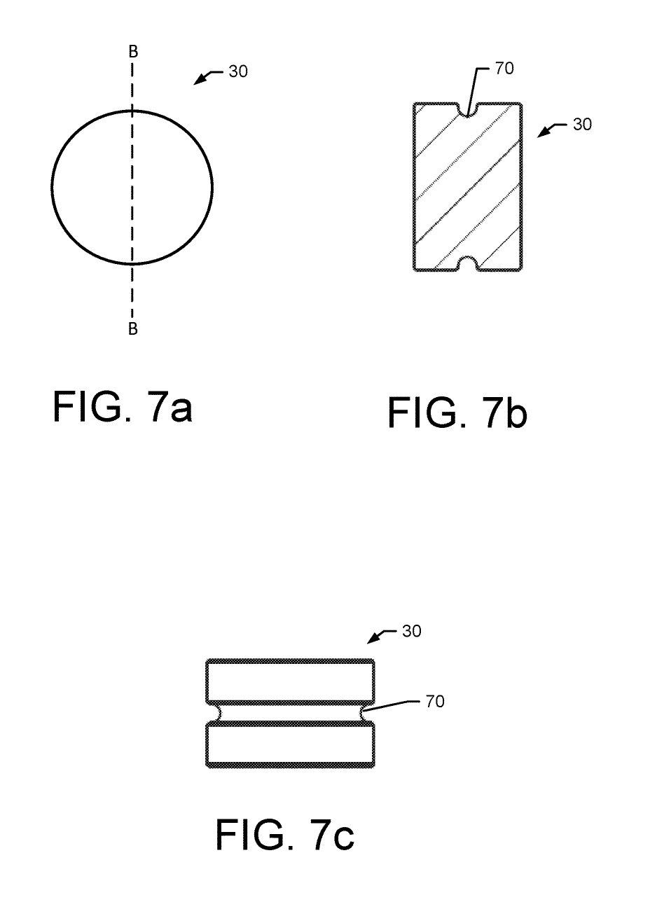

FIG. 5 is a exploded, perspective top view of an apparatus for suspending an item according to an example embodiment. The carrier 20 of FIG. 5 is shown prior to the magnets 30 being assembled into the chambers 40. According to some embodiments, the internal surface of the chambers 40 may include a raised portion or tongue 60. Additionally, the magnets 30 may include a groove 70. During assembly, the magnets 30 may be press fit into the chambers 40 such that the tongue 60 engages the groove 70. According to some example embodiments, the magnets 30 may be affixed to the carrier 20 via other techniques, such as via an adhesive or overmolding.

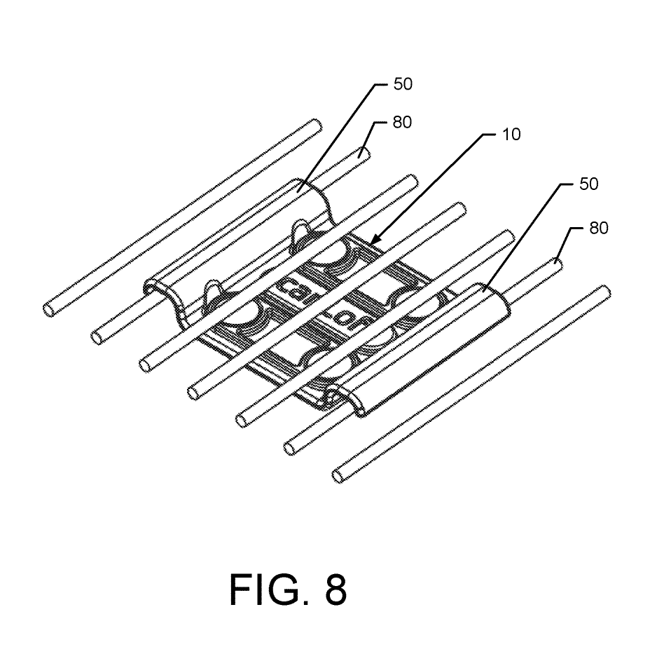

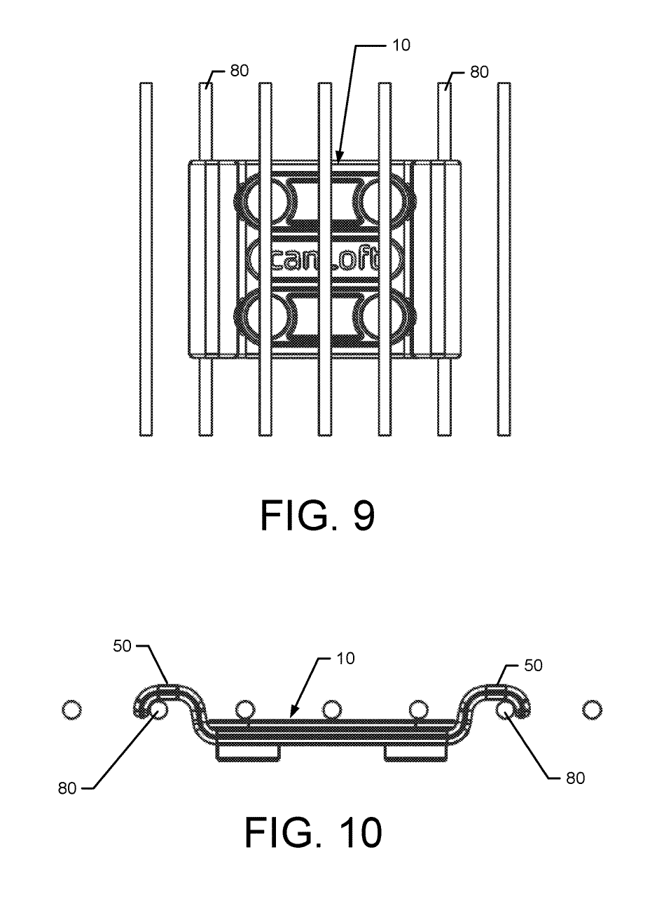

FIG. 8 is a top, perspective view of an apparatus for suspending an item removably secured to a shelving rods according to some example embodiments. As shown in FIG. 8, the shelving rods 80 can be engaged with the hooks 40 such that the hooks 40 pass over the top of the rods 80 to secure the apparatus 10 to a shelf that includes the rods 80. Rods 80 may be wire rods of a wire shelf, but rods could be plastic or comprised of other materials.

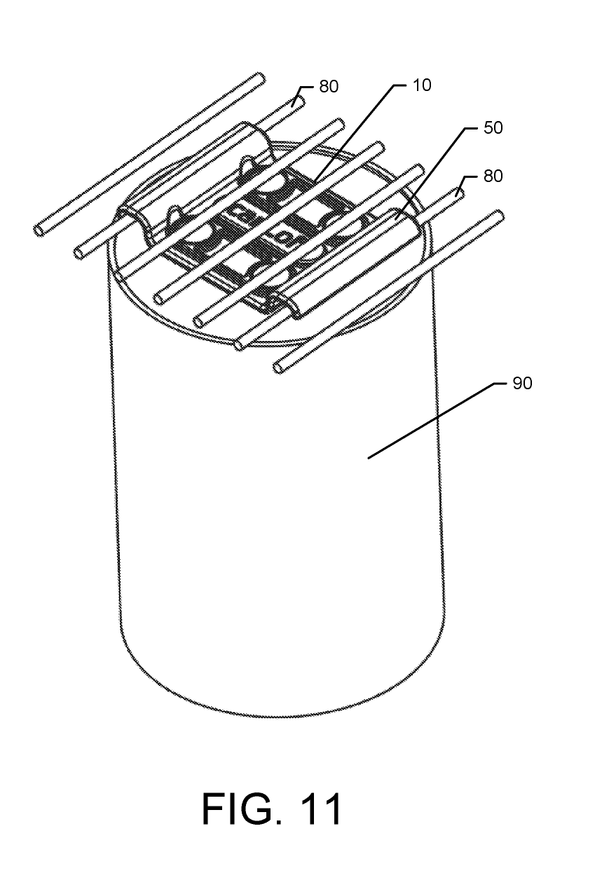

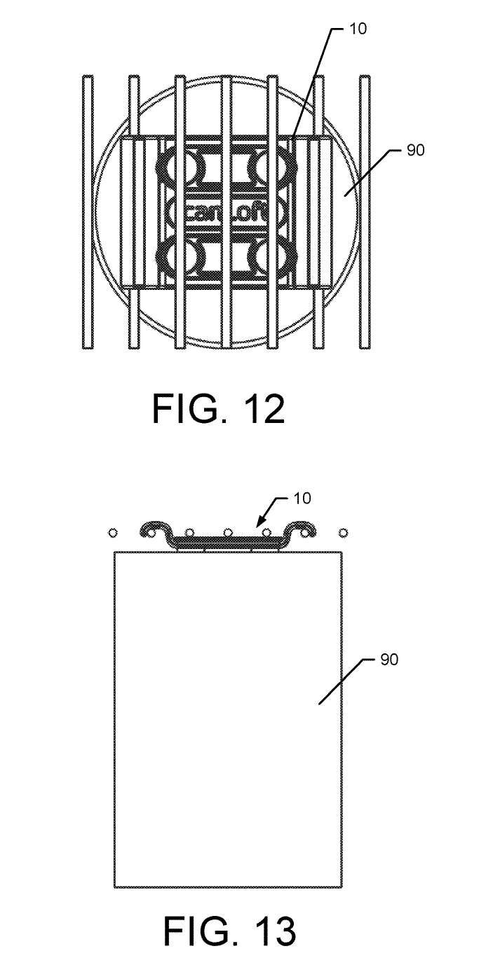

FIG. 11 is a top, perspective view of an apparatus for suspending an item removably secured to shelving rods 80 and suspending an item 90 according to some example embodiments. The item 90 may be a can and may be suspended to the underside of the shelf b the apparatus 10.

Many modifications and other example embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific example embodiments disclosed and that modifications and other embodiments are intended to be included within the scope of this disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of this disclosure. In this regard, for example, different combinations of elements and/or functions than those explicitly described above are also contemplated as may be set forth in some of this disclosure. Although specific terms are employed herein, they are used in a generic and descriptive sense only and not for purposes of limitation.

What is claimed is:

1. An apparatus for suspending an item comprising:
a carrier including a chamber and a hook, wherein the hook is configured to engage a rod of a shelf to removably secure the apparatus to the shelf; and
a magnet disposed within the chamber.
